(19) United States
(12) Patent Application Publication
(10) Pub. No.: US 2006/0254859 A1
(43) Pub. Date: Nov. 16, 2006

(54) Universal ladder leveler

(76) Inventors: Anthony Joseph Redekas, Newington, CT (US); Gary Stephen Redekas, Tariffville, CT (US)

Correspondence Address: ANTHONY JOSEPH REDEKAS, 910 WILLARD AVE., NEWINGTON, CT, 06111, US

(21) Appl. No.: 11/126,694

(22) Filed: May 11, 2005

(51) Int. Cl. E06C 7/00

(52) U.S. Cl. 182/204

(57) ABSTRACT

An improved ladder leveler which is made up of a tapered inner square bar and outer square tube which slide axially in relation to each other to vary the degree of extension. Locking the same in position by turning a threaded bolt until said bolt touches the tapered surface of said inner square bar. (See drawings) The ladder required to make our invention universally adjustable to compensate for differences in uneven terrain, whether sloping downward from left to right, or right to left will be built with one leg shorter than the other. The unit will be attached to said shortened leg. Said leveling and locking system differs from prior art in that there are no incrementally spaced holes to receive a locking pin. We find those systems to be inconvenient as the holes are in the adjustable legs which are inside an outer sleeve and therefore invisible to the user who is required to search for the hole that most nearly locks the leg at its required length. This adjustable leg simply falls to the ground to its exact required length. Said threaded bolt is tightened securing said leg safely where needed. Since said locking bolt is a part of said ladder leveler, it holds said tapered inner square bar to the exact degree of extension and cannot slide downward as said tapered leg gets progressively bigger. Other patents we have researched require two adjustable legs per ladder permanently affixed (after market) or one removable leg that can be alternately used on either leg of the ladder as the slope of the terrain requires.

The universal ladder leveler can also be manufactured in different sizes to be installed on step ladders, saw horses, certain types of staging supports, and possibly other equipment that we have not thought of.

We seek to patent the concept of the tapered adjustable leg for multiple uses.

Installation of our invention after market on existing conventional ladders will require that one leg of the ladder be cut off to just below the first rung. References Cited U.S. Patents 1,862,171 6/1937 Baker 182/205 3,165,170 1/1965 Bloney 2,517,771 8/1950 Stefano 182/203 4,607,726 8/1986 Davis 2,783,928 3/1957 Cox 182/203 4,984,655 1/1991 Scherer

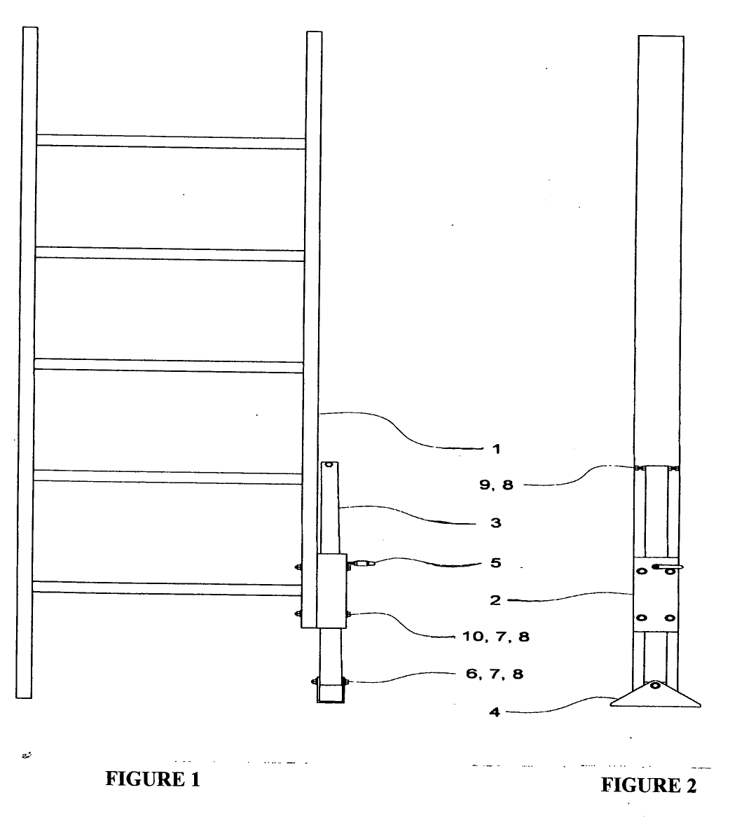

FIG. 1.
Front view of ladder with adjustable leg attached.

FIG. 2.
Side view of ladder with adjustable leg attached

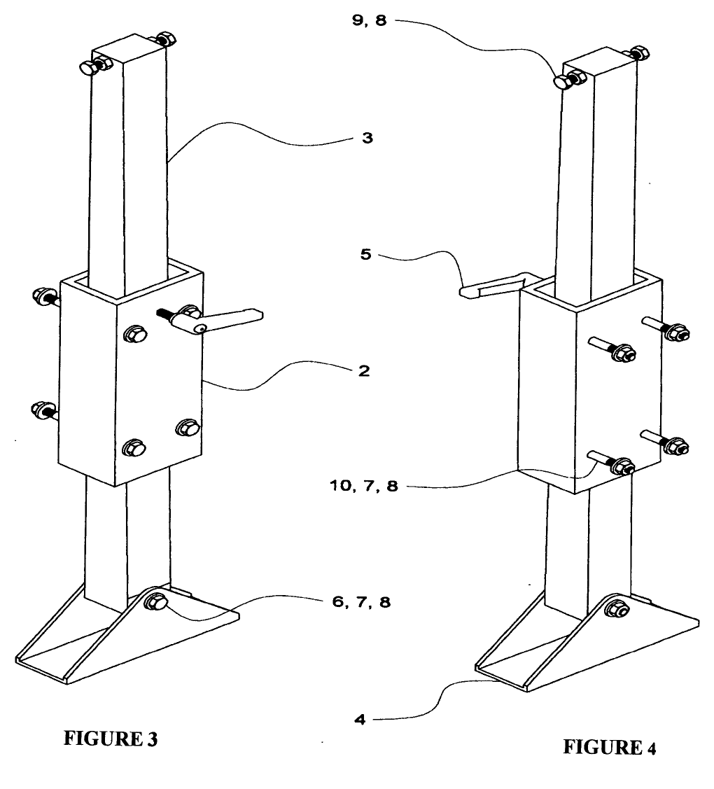

FIG. 3.
Perspective view of ladder leveler unattached to ladder - face side

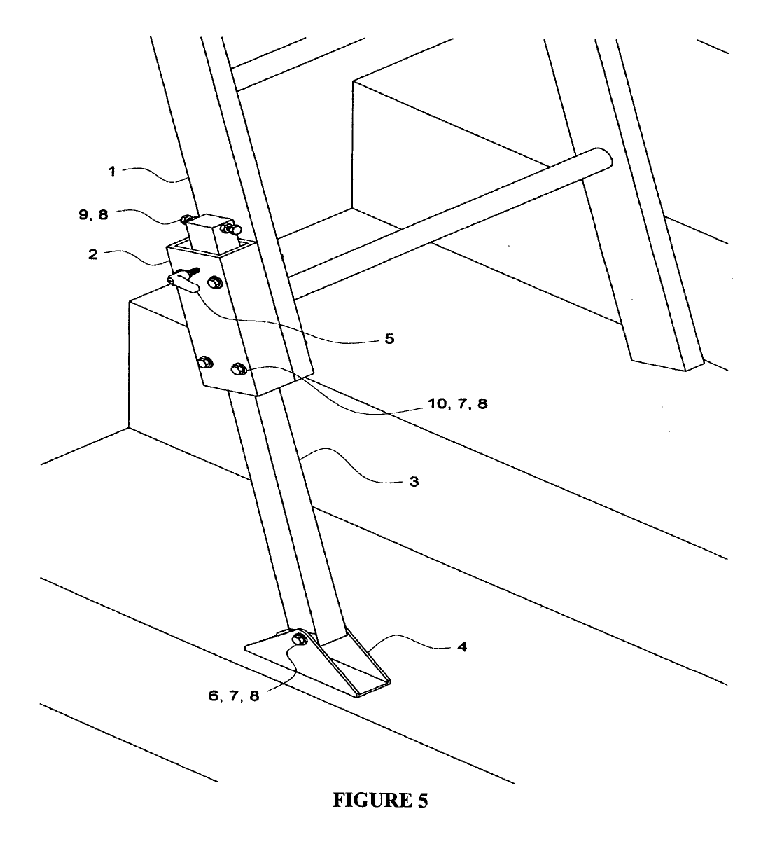

FIG. 4.

Perspective view of ladder leveler depicting back side
FIG. 5.

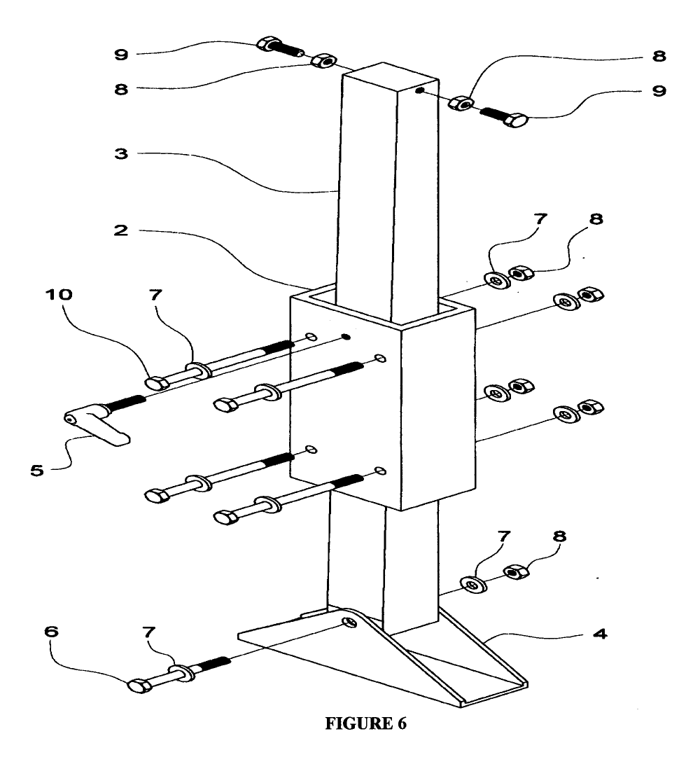

Perspective view of ladder and adjustable leg extended on stairs
FIG. 6.

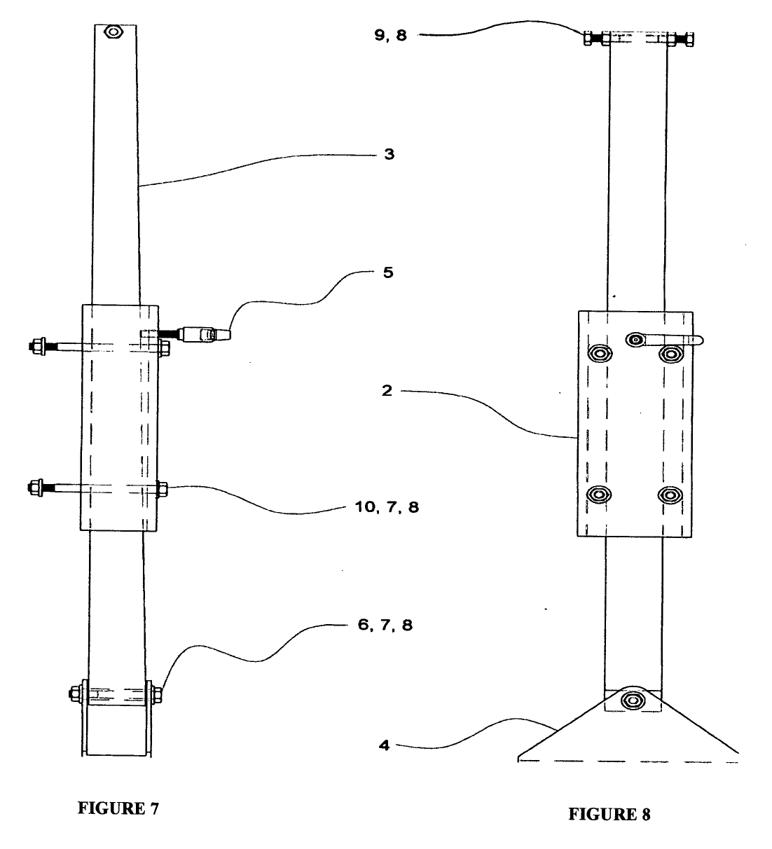

Exploded view of leveler with component parts numbered
FIG. 7.

Front view of leveler not attached to ladder
FIG. 8.

Side view of leveler not attached to ladder

### PARTS LIST

1. Ladder (shortened leg)
2. Sleeve for adjustable leg
3. Tapered adjustable leg
4. Rotateable foot pad
5. Handle of locking bolt
6. Bolt holding foot pad
7. Washers
8. Nuts
9. Bolt to prevent adjustable leg from falling through sleeve
10. Bolts for attaching adjustable leg unit to ladder

1. An extendable tapered square leg, which is universally adjustable to compensate for uneven terrain, whether said terrain slopes downward from right to left, or left to right.

2. A locking system which is unique, instant and safe.

3. A tapered upper portion of adjustable leg eliminates the need for incrementally spaced holes and locking pin as found on prior art patents.
